(19) United States
(12) Patent Application Publication
(10) Pub. No.: US 2025/0136882 A1
(43) Pub. Date: May 1, 2025

(54) COMPOSITIONS OF DRAG REDUCING POLYMERS AND USE THEREOF

(71) Applicant: Liquidpower Specialty Products Inc., Houston, TX (US)

(72) Inventor: Minjung CHO, Stillwater, OK (US)

(21) Appl. No.: 18/932,241

(22) Filed: Oct. 30, 2024

Related U.S. Application Data
(60) Provisional application No. 63/594,497, filed on Oct. 31, 2023.

(51) Int. Cl. C10L 1/16; B05D 7/22; C08F 10/14; C08F 210/14

(52) U.S. Cl. CPC C10L 1/1641; B05D 7/222; C08F 10/14; C08F 210/14

(57) ABSTRACT

A drag reducing composition includes a drag reducing polymer; a magnetic particle incorporated in the drag reducing polymer; and a suspension fluid medium. In some compositions, the magnetic particle comprises a fatty acid and/or at least one of a magnetic metal, a magnetic metal alloy, or a metal oxide core. A method of forming a drag reducing composition includes reacting alpha-olefin monomers in the presence of a polymerization catalyst and a magnetic particle to produce a drag reducing polymer incorporated with the magnetic particle.

### CROSS-REFERENCE TO RELATED APPLICATIONS

This application claims the benefit of U.S. Provisional Application No. 63/594,497, filed on Oct. 31, 2023, which application is incorporated herein by reference in its entirety.

### BACKGROUND

### Field

Implementations described herein generally relate to drag reducing polymers. In particular, implementations described herein relate to compositions of drag reducing polymers. In particular still, implementations described herein relate to methods of removing drag reducing polymers from a hydrocarbon stream.

### Description of the Related Art

The flow of liquid in a conduit, such as a pipeline, typically results in frictional energy losses. Due to this energy loss, the pressure of the liquid in the conduit decreases along the conduit in the direction of the flow. For a conduit of fixed diameter, this pressure drop increases with increasing flow rate.

Generally, ultra-high molecular weight poly α-olefins have excellent affinity to hydrocarbon fuels, and thus offers high drag reduction. It is utilized as an additive for pipeline transportation of gasoline and diesel to either reduce the energy consumption or to increase the pipeline throughput capacity. These polymers may be referred to as drag reducing polymers (“DRA”). As the dissolved polymer molecules flow through the pipelines and pump stations, they are mechanically sheared into smaller molecular weight fragments.

Drag reducing polymers have not been adopted for use in jet fuel because the polymer fragments may interfere with engine re-ignition at high altitude. Aviation turbine fuel contaminated with DRAs are typically downgraded to non-aviation kerosene or diesel fuel, resulting in loss of market value. DRAs are also not recommended for use with natural gas liquids because the polymer fragments may interfere with the fractionation processing of the y-grade natural gas liquids.

There is a need, therefore, for an improved method of removing the drag reducing polymers from hydrocarbons.

### SUMMARY

In one embodiment, a drag reducing composition includes a drag reducing polymer; a magnetic particle incorporated in the drag reducing polymer; and a suspension fluid medium. In some embodiments, the magnetic particle comprises a magnetic metal, magnetic metal alloy, or magnetic metal oxide. In some embodiments, the magnetic particle further comprises a fatty acid. In some embodiments, the magnetic particle comprises a magnetic metal, magnetic metal alloy, or a metal oxide core and a fatty acid.

In another embodiment, a method of forming a drag reducing composition includes providing alpha-olefin monomers with a carbon chain length of between two and twenty carbon atoms and providing a polymerization catalyst. A magnetic particle in an amount from 1% to 5% by total volume is added to the drag reducing composition. The method also includes reacting the alpha-olefin monomers in the presence of the polymerization catalyst to produce a drag reducing polymer incorporated with the magnetic particle. In some embodiments, the method includes synthesizing the magnetic particle by mixing a magnetic metal oxide with a fatty acid.

In another embodiment, a method includes supplying a drag reducing composition into a hydrocarbon stream flowing in a conduit. The drag reducing composition includes a drag reducing polymer and a magnetic nanoparticle. The drag reducing polymer is present in an amount sufficient to reduce drag of the hydrocarbon stream. The method also includes applying a magnetic force to the hydrocarbon stream and removing at least a portion of the drag reducing polymers using the magnetic force.

### DETAILED DESCRIPTION

Different aspects, implementations and features are defined in detail herein. Each aspect, implementation or feature so defined may be combined with any other aspect(s), implementation(s) or feature(s) (preferred, advantageous or otherwise) unless clearly indicated to the contrary.

As used herein, the singular forms “a,” “an,” and “the” include plural referents unless the context clearly indicates otherwise.

As used herein, the terms “comprising,” “including” and “having” are intended to be inclusive and mean that there may be additional elements other than the listed elements.

As used herein, the term “alpha-olefin” refers to an olefin that has a double bond between the first and second carbon atom. The term “alpha-olefin” includes linear and branched alpha-olefins unless expressly stated otherwise. In the case of branched alpha-olefins, a branch may be at the 2-position (a vinylidene olefin) and/or the 3-position or higher with respect to the olefin double bond. The term “alpha-olefin,” by itself, does not indicate the presence or absence of heteroatoms and/or the presence or absence of other carbon-carbon double bonds unless explicitly indicated. The term “hydrocarbon alpha-olefin” or “alpha-olefin hydrocarbon” refers to alpha-olefin compounds containing only hydrogen and carbon. The terms “alpha-olefin” and “terminal olefin” can be used interchangeably.

The following disclosure describes methods and apparatus for removing drag reducing polymers from a liquid hydrocarbon stream flowing in a conduit. In some embodiments, magnetic nanoparticles are incorporated into the drag reducing polymers. The drag reducing polymer and magnetic nanoparticle complex can be dispersed in the liquid hydrocarbon stream in the conduit. Thereafter, a magnetic capturing process can be performed to remove the drag reducing polymers from the liquid hydrocarbon stream.

In some embodiments, the drag reducing polymer is an ultra-high molecular weight polymer that is typically a linear poly(α-olefin) composed of monomers with a carbon chain length of between two and twenty carbons or mixtures of two or more such linear poly(α-olefins). In some embodiments, the linear poly(α-olefins) include, but are not limited to, poly(1-octene), poly(1-nonene) and poly(1-decene). In one embodiment, the ultra-high molecular weight polymer is a copolymer, i.e., a polymer composed of two or more different types of monomers, as long as all monomers used have a carbon chain length of between two and twenty carbons. Other polymers of a generally similar nature that are soluble in the liquid hydrocarbon will also function as suitable drag reducing polymers. Thus, it will be understood that although reference is made to poly alpha-olefins, other polymers known to reduce drag or friction in hydrocarbons, and other polymers in general may be used in the compositions and methods of the disclosure. In one embodiment, the drag reducing polymer includes methacrylate.

In some embodiments, the drag reducing polymers are copolymers formed from a majority of alpha-olefin monomers with a carbon chain length of between four and nine carbon atoms. The polymers may be formed with a minority fraction composed of other alpha-olefins with carbon chain lengths of between two and twenty carbons, but preferably formed from monomers such as ethylene, propylene, decene, dodecane, or vinyl aromatic monomers of any carbon number. Examples of the vinyl aromatic monomer include styrene, an alkyl-styrene with an alkyl group having between one and eighteen carbon atoms, a vinyl naphthalene, and a vinyl alkylnaphthalene with an alkyl group having between one and eighteen carbon atoms. Some examples of copolymers include, but are not limited to: 80% octene/20% decene, 70% octene/30% decene, 90% octene/10% dodecane, and 70% octene/30% propylene (all molar ratios). In one example, alpha-olefin monomers having a carbon number between four and nine make up at least 60% of the copolymer. The copolymers may be formed with more than two monomers, as long as the majority fraction is composed of alpha-olefin monomers having a carbon number between four and nine and little or no monomers with twelve or more carbons in the chain. Examples include, but are not limited to: 70% octene/20% decene/10% propylene, 60% octene/20% hexene/20% butene, 70% octene/20% decene/10% dodecane, 40% octene/30% hexene/30% decene, and 45% octene/45% hexene/10% styrene.

In one embodiment, the drag reducing composition is formed through bulk polymerization. In some embodiments, other polymerization methods are acceptable, including but not limited to solution polymerization. When produced through bulk polymerization, the polymerization medium primarily contains a catalyst and monomers, such as alpha-olefin monomers. In some embodiments, a diluent hydrocarbon can be present.

The bulk polymerization may be carried out using any polymerization catalyst, and in some embodiments, can be Ziegler-Natta catalysts. The Ziegler-Natta catalysts used can be any of those described in the art. In some embodiments, useful materials are those described in U.S. Pat. Nos. 4,358,572; 4,415,714; 4,493,903; and 4,493,904, which are incorporated by reference. Appropriate metallocene catalysts may also be used. In bulk polymerization systems, catalysts are typically used at a concentration of 3500 moles monomer per mole transition metal halide in the catalyst, although ratios can vary from as low as 500:1 to as high as 10000:1 or more. Catalyst concentration affects rate of reaction and temperature as well as molecular weight. These catalysts often are more effective when used in the presence of a promoter, such as dibutyl ether, or a co-catalyst, such as diethyl aluminum chloride (DEAC).

For polymerization reactions that are incomplete, removal of unreacted monomers is advantageous and may be carried out by vacuum drying and/or vacuum drying with precipitation according to techniques known to those skilled in the art. However, a bulk reaction can be carried out to substantial completion, for example, 99% completion or more, and the drying step to remove monomer and/or solvent avoided if possible.

In one embodiment, the drag reducing polymer can be made by solution polymerization of the monomers followed by removal of the solvent. In solution polymerization, the hydrocarbon solvent, catalyst, and monomers are combined in a reacting vessel and agitated under a nitrogen atmosphere at ambient pressure. It may be necessary to cool the reaction vessel prior to the reaction or during the reaction, depending on the equipment used, conversion desired, and concerns over polymeric degradation. As the solution becomes viscous, the agitation is discontinued and the reaction is allowed to proceed to greater than 50% conversion, or greater than 95% conversion, or even greater than 99% conversion. After the completion of the polymerization, the polymer solution may be contacted with a non-solvent to precipitate the polymer and extract the polymerization solvent and unreacted monomer, as is taught in U.S. Pat. No. 5,376,697. Alternatively, if the hydrocarbon solvent boils at a low temperature, it can be removed by heating, exposure to vacuum, or both. Combinations of extraction by a non-solvent, heating and/or vacuum may be used, as apparent to one skilled in the art.

In one embodiment, the drag reducing polymer has a molecular weight in excess of one million or in excess of five million.

In one embodiment, bulk or solution polymerization is followed by granulation and/or grinding to produce a particulate polymer composition, such as polymer particles. The granulation and/or grinding may be conducted at cryogenic or non-cryogenic temperatures. In one embodiment, the granulation and/or grinding occurs at temperatures below the glass transition temperature of the polymer and then mixed in a carrier fluid. Glass transition temperatures vary with the type of polymer and generally range between −10° C. to −100° C. This temperature may vary depending on the glass transition point of the particular polymer or copolymer, but normally such temperatures are below the lowest glass transition point of a polymer that comprises a polymer blend. In a further embodiment, grinding for production of the polymer particles may be conducted at ambient temperature. However, it is preferable to cool the drag reducing polymer to between 5° C. and 15° C. when grinding the drag reducing polymer. Cooling may be accomplished either internally or externally, or both, with a liquid, gaseous, or solid refrigerant, or a combination thereof. In one embodiment, the drag reducing polymer may be cooled by spraying a liquid refrigerant, such as liquid nitrogen, liquid helium liquid argon, or a mixture of two or more such refrigerants.

In some embodiments, a magnetic particle is incorporated into the drag reducing polymers during the polymerization process. An exemplary magnetic particle is a magnetic nanoparticle. Suitable magnetic nanoparticles include a superparamagnetic metal or metal oxide nanoparticle and a ferromagnetic metal or metal oxide nanoparticle. The magnetic nanoparticles may include any metal or metal oxide useful for forming a magnetizable composition or alloy. Useful metals include in particular those of the group 6, 7, 8, 9, 10, and 11 metals, as well as main group metals and the lanthanides. Exemplary metals for this purpose include Ag, Al, Au, Co, Cu, Fe, Hf, In, Ir, Mo, Nd, Ni, Pd, Pt, Rh, Ru, Sm, Sn, Ti, V, Y, Zr, alloys thereof, or a combination comprising at least one of the foregoing. In some embodiments, exemplary metals include Fe, Co, Ni, Pt, Nd, Sm, alloys thereof, and combinations comprising at least one of the foregoing.

The magnetic nanoparticles may have an average particle size of about 1 nanometer (nm) to about 1 micrometer (μm). In some embodiments, the magnetic nanoparticles have an average particle size of less than about 800 nm, and more specifically a largest average particle size of less than or equal to about 500 nm, and still more specifically less than or equal to about 250 nm. In some embodiments, the magnetic nanoparticles have an average particle size of about 1 nm to about 100 nm, about 5 to about 75 nm, and about 10 to about 50 nm. As used herein, “average particle size” refers to particle size measurements based on number average particle size measurements, which can be routinely obtained by laser light scattering methods such as static or dynamic light scattering (SLS or DLS, respectively).

In some embodiments, the magnetic nanoparticle may exhibit superparamagnetic behavior, which include properties such as zero coercivity and better colloidal stability. When the magnetic field is removed from these nanoparticles, thermal energy allows the nanoparticles to freely reorient their spins so that no external energy needs to be applied to demagnetize the system. In other words, in the absence of an external magnetic field, the net magnetic reflux of the nanoparticles is zero. As such, the nanoparticles are stable during synthesis and under physiological condition. Exemplary magnetic nanoparticles exhibiting superparamagnetic behavior may have an average particle size range from 5 nm to 50 nm or from 8 nm to 50 nm. In one example, the magnetic nanoparticles have an average particle size range from 5 nm to 30 nm.

In some embodiments, the magnetic nanoparticle may be formed by thermal composition of iron carboxylate salts or iron oxide salts. The magnetic nanoparticles may include a magnetic metal or metal oxide such as iron, cobalt, nickel, platinum, and alloys of these metals. In one example, the synthesis process of monodisperse iron oxide magnetic nanoparticles involves growing magnetic metal oxide core particles and stabilizing the magnetic metal oxide core particles using a fatty acid. In one example, iron oxide may be dissolved in oleic acid. Other suitable fatty acids include 10-undecenoic acid, lauric acid, myristic acid, stearic acid, linoleic acid, decylenic acid, 8-nonenoic acid, 7-octenoic acid, and other suitable fatty acids. In another example, monounsaturated fatty acids are also suitable, including palmitoleic acid, elaidic acid, and vaccenic acid. Suitable fatty acids also include omega-9 fatty acids such as hypogeic acid, oleic acid, gondoic acid, mead acid, and erucic acid. The molar ratio of the magnetic metal oxide to the fatty acid can be from 1:1 to 1:8, from 1:2 to 1:6, or from 1:3 to 1:5. The mixture is heated to a first temperature from 50° C. to 150° C. under an inert gas environment (e.g., N₂ or Ar) and held for a first time period from 0.5 hr to 3 hr. Without wishing to be bound by theory, it is believed that during the first time period, residual water is removed from the mixture. In some examples, it is possible that the iron oxide precursor is dissolved in fatty acid, and the iron-fatty acid intermediate complex is formed. Unreacted fatty acid is dimerized with the fatty acid ligand via hydrophobic interaction. In a second time period, the mixture is heated to a second temperature from 155° C. to 250° C. The second time period may be from 0.25 hr. to 3 hr. Without wishing to be bound by theory, it is believed that the fatty acid ligand is decomposed from the iron-fatty acid complex and metastable iron oxide nuclei is formed during the second time period. In some embodiments, holding the mixture at the first temperature during the first time period is optional. Instead, the mixture may be held at the second temperature for a longer time period. During the third time period, the mixture is heated to a third temperature from 250° C. to 350° C. The third time period may be from 0.5 hr. to 3 hr. It is believed that the residual fatty acid molecules are completely removed from the iron-fatty acid complex, leading to the growth of iron oxide magnetic nanocrystals. After the third time period, the mixture is allowed to cool down to room temperature.

The resulting magnetic metal-carboxylate colloidal mixture may be purified by adding suitable short chain alcohols and/or ketones and then centrifuged. Exemplary alcohols and ketones include methanol and acetone. The precipitates from the purification can be dispersed in an organic liquid, such as hexane or 1-decene. The iron oxide magnetic nanoparticles possessed superparamagnetic properties which responded to an external magnet.

In some embodiments, the magnetic nanoparticles are incorporated into the drag reducing polymers. For example, the magnetic nanoparticles may be added along with the catalysts during the bulk polymerization process of forming the drag reducing polymer. The magnetic nanoparticles may be added in an amount sufficient to provide a concentration from 0.01% to 0.05% of iron in the magnetic nanoparticles by total weight. In some embodiments, the magnetic nanoparticle suspension is added to the polymerization process in an amount sufficient to provide from 1% to 5% of magnetic nanoparticle suspension by total volume. The concentration of magnetic nanoparticles in the drag reducing polymer is from 0.1% to 0.5% of the total weight. The synthesized drag reducing polymer is an ultra-high molecular weight polymer having a molecular weight greater than 1 million. It has been found that the addition of the magnetic nanoparticles does not significantly change the properties of the drag reducing polymer. For example, properties such as inherent viscosity, solid weight percentage, and drag reducing are not significantly changed after adding the magnetic nanoparticle. In this respect, the resulting drag reducing polymers containing the magnetic nanoparticles remain suitable for use as drag reducing agents.

In one embodiment, bulk or solution polymerization is followed by granulation and/or grinding to produce a particulate polymer composition, such as polymer particles. The granulation and/or grinding may be conducted at cryogenic or non-cryogenic temperatures. In one embodiment, the granulation and/or grinding occurs at temperatures below the glass transition temperature of the polymer and then mixed in a carrier fluid. Glass transition temperatures vary with the type of polymer and generally range between −10° C. to −100° C. This temperature may vary depending on the glass transition point of the particular polymer or copolymer, but normally such temperatures are below the lowest glass transition point of a polymer that comprises a polymer blend. In a further embodiment, grinding for production of the polymer particles may be conducted at ambient temperature. However, it is preferable to cool the drag reducing polymer to between 5° C. and 15° C. when grinding the drag reducing polymer. Cooling may be accomplished either internally or externally, or both, with a liquid, gaseous, or solid refrigerant, or a combination thereof. In one embodiment, the drag reducing polymer may be cooled by spraying a liquid refrigerant, such as liquid nitrogen, liquid helium liquid argon, or a mixture of two or more such refrigerants.

Granulation and/or grinding of the drag reducing polymer to form polymer particles will be performed in the presence of a partitioning agent, which is added to prevent the freshly exposed surfaces of the polymer particles from sticking together. A small amount, typically less than 5% and preferably less than 4% by weight of the total mixture, of the partitioning agent, may be added during the granulation process in order to prevent agglomeration of the small polymer particles. In one embodiment, polymer particles are in contact with the partitioning agent, which prevents polymer particles from sticking to each other. The polymer particles may be at least partially coated, fully coated, or dusted with the partitioning agent. A sufficient amount of the partitioning agents are in contact with the polymer particles to prevent agglomeration of the polymer particles.

In some examples, the partitioning agent is a fatty wax such as stearamide. In some examples, the partitioning agent is a tackifier. For example, the tackifier may include one or more of a coal-tar resin, a C5 aliphatic petroleum resin, a C9 aromatic petroleum resin, C5/C9 aliphatic/aromatic petroleum resin, a cycloaliphatic diene-based petroleum resin, a pure monomer resin, a terpene resin, a terpene phenol resin, a styrenated terpene resin, a rosin resin, a rosin resin derivative, one or more of an alkylphenol resin, a modified alkylphenol resin, and fully or partially hydrogenated form thereof.

The polymer particles with the partitioning agent formed following granulation can then be transported to a pre-cooler. The transport can be accomplished by any number of typical solids handling methods, including through the use of an auger or pneumatic transport system. The pre-cooler can be an enclosed screw conveyor with nozzles for spraying a liquid refrigerant, such as liquid nitrogen, liquid helium, liquid argon, or mixtures thereof, onto the polymer pieces. While a gaseous refrigerant may also be used alone, the cooling efficiency is often too low. The pre-cooler reduces the temperature of the polymer particles to a temperature below the glass transition temperature of the polymer. In one embodiment, this temperature is below −130° C., and in another embodiment, the temperature is below −150° C. These temperatures can be produced by any known methods, and in one embodiment includes use of liquid refrigerant such as liquid nitrogen, helium, argon, or a mixture of two or more such refrigerants sprayed directly onto the polymer, as the resulting atmosphere reduces or eliminates flammability hazards that exist when polymer particles are mixed with an oxygen-containing atmosphere. The rate of addition of the liquid refrigerant may be adjusted to maintain the polymer within the required temperature range.

Following cooling, the polymer particles with the partitioning agent are transported to a cryomill. A liquid refrigerant can be added to the cryomill in order to maintain the temperature of the polymer particles below the glass transition temperature of the ultra-high molecular weight polymer, such as between −130° C. and −150° C. The cryomill acts to reduce the particle size of the polymer particles it receives from the pre-cooler.

The polymer particles with the partitioning agent formed in the cryomill are then transferred to a separator where most of the liquid refrigerant vaporizes. The separator acts to separate the primarily vaporized refrigerant atmosphere from the solid polymer particles, and the larger polymer particles from the small polymer particles. Larger polymer particles having diameters higher than a set minimum diameter are discarded or returned for recycle purposes to the pre-cooler for regrinding.

The small polymer particles with the partitioning agent are then mixed with a carrier or suspending fluid to form a suspending fluid/polymer particle mixture. The suspending medium can include one or more of (a) alcohols containing less than 14 carbon atoms, (b) glycols containing less than 14 carbon atoms, and (c) glycol ethers. Suspensions can also be made with propylene glycol, di(propylene glycol) methyl ether, or tri(propylene glycol) methyl ether. Exemplary suspending medium also include polyunsaturated fatty acid. It will be realized by those skilled in the art that various mixtures of these various carbon atom length alcohols, glycols and glycol ethers can be used to provide a “tailored” suspending medium for the particular polyolefin loading and service conditions. In particular, it should be noted that a particular mixture can vary depending upon factors such as stability, solubility, long-term storage, and compatibility with the flowing hydrocarbon.

Additional components may be added to the suspending fluid/polymer particle mixture before, during or after mixing the ground polymer particles with the suspending fluid in order to aid the formation of the suspension and/or to maintain the suspension. Such additional components include but are not limited to glycols, wetting agents, antifoaming agents, and the like.

Relative proportions of each suspension component, including drag reducing polymer, partitioning agent, suspension medium etc., will have an effect upon the final properties, including but not limited to stability to settling, separation and/or agglomeration, of the suspension. While a wide range of proportions may be employed according to the desirable properties of the final suspension, it has been found that, in certain embodiments, a ratio of drag reducing polymer to overall suspension ranging from about 10 to about 50 percent by weight is effective. In other embodiments, a ratio of drag reducing polymer to overall suspension may range from about 25 to about 35 percent by weight. Where additional partitioning agent is to be included, it may be, in certain non-limiting embodiments, in the range of from about 2 to about 30 percent by weight, as compared to the overall suspension.

In some embodiments, additional magnetic nanoparticles may be added to the suspension to promote the magnetic response of the drag reducing polymer in the presence of a magnet. For example, additional magnetic nanoparticle suspension can be added to make up from 1% to 5% of magnetic nanoparticle suspension by volume of the total volume of the polymerization. In some embodiments, the additional magnetic nanoparticles has a size range from 8 nm to 400 nm or from 10 nm to 50 nm. The additional magnetic nanoparticles may have the same or different size as the magnetic nanoparticle that was incorporated to the drag reducing polymer.

The drag reducing composition described herein can be, in some embodiments, utilized for drag reduction in a variety of streams, such as hydrocarbons, including, for example, crude oil, heating oil, liquefied natural gas, jet fuel, kerosene, refined gas, gasoline and diesel fuel. In use, the drag reducing polymer containing suspension is generally added in a proportion, based on weight of the hydrocarbon stream, of from about 5 ppm to about 100 ppm, or from about 8 ppm to about 60 ppm.

The disclosure will be further illustrated by the following examples, which sets forth particularly advantageous embodiments. While the examples are provided to illustrate the present disclosure, they are not intended to limit it.

### Example 1

Synthesis of Iron Oxide Magnetic Nanoparticles (8-13 nm size) with Oleic Acid: 0.178 g of Iron oxide hydrated (“FeO(OH)”, 2 mmol), 2.26 g oleic acid (“OA,” 8 mmol) and 5 g 1-octadecene (“ODE”) were mixed in a 100 ml three neck flask and heated to 120° C. for 2 hours to remove residual water. The reaction mixture was further heated to 240° C. for 30 minutes to synthesize iron carboxylate, iron-oleate, (“magnetic nanoparticle”). Then, the reaction mixture was heated to 315° C. for 2 hours under N₂ condition and thereafter, cooled down to room temperature. Then, 30 ml of hexane was added to the resulting colloidal solution in the flask to disperse the magnetic nanoparticles. To purify the resulting colloidal solution, 20 ml of methanol and 20 mL of acetone were added to 5 mL of the colloidal solution and centrifuged at 4150 rpm for 30 minutes. The precipitates at the bottom were re-dispersed using hexane, and this process was repeated six times. Finally, 8 nm iron oxide nanocrystals were purified and dispersed in hexane or 1-decene.

To synthesize 13 nm iron oxide nanocrystals, the molar ratio of iron oxide hydrated to oleic acid was changed from 1:3 to 1:5 with all other conditions remaining the same.

### Example 2

Synthesis of Iron Oxide Magnetic Nanoparticles (21 nm size) with 10-undecenoic acid: 0.178 g of Iron oxide hydrated (2 mmol), 1.47 g 10-undecenoic acid (“UDC,” 8 mmol) and 5 g 1-ODE were mixed in a 100 ml three neck flask and heated to 120° C. for 2 hours to remove residual water. The reaction mixture was further heated to 240° C. for 30 minutes to synthesize iron carboxylate, iron-oleate. Then, the reaction mixture was heated to 315° C. for 2 hours under N₂ condition and thereafter, cooled down to room temperature. Then, 30 ml of hexane was added to the resulting colloidal solution in the flask to disperse the magnetic nanoparticles. To purify the resulting colloidal solution, 20 ml of methanol and 20 mL of acetone were added to 5 mL of the colloidal solution and centrifuged at 4150 rpm for 30 minutes. The precipitates at the bottom were re-dispersed using hexane and this process was repeated six times. Finally, 21 nm iron oxide nanocrystals were purified and dispersed in hexane or 1-decene.

### Example 3

Synthesis of Iron Oxide Magnetic Nanoparticles (200-400 nm size): 0.53 g of iron (III) acetylacetonate (1.5 mmol) was mixed with 1.27 g of oleic acid (4.5 mmol), 0.4 g of 4-biphenyl carboxylic acid (2 mmol), and 20 g of benzyl ether (150 mmol). The mixture was heated to 60° C. for 1 hour and then further heated to 200° C. for 2 hours. When the temperature reached to 280° C. at the rate of 20° C./min, the reaction mixture was maintained at this temperature for 1 hour under nitrogen. After cooling down to room temperature, the resulting colloidal solution was transferred and dispersed in hexane solution. The solution was purified by adding 35 ml acetone and was centrifuged at 4000 rpm for 30 minutes with repeated cycles at least 6 times. The black precipitated pellets were re-dispersed using hexane or 1-decene.

### Example 4

Incorporation of Magnetic Nanoparticles into Drag Reducing Polymerization

A sample of 1-decene (500 g) was purged with nitrogen and transferred into a glove box along with a second 1-decene sample (500 g) containing dispersed purified magnetic nanoparticles Catalyst was added to each sample to initiate the polymerization.

Once the polymerization was complete, the drag reducing polymers were tested for % solids (% wt), and drag reduction (DR) following standard procedures. The test results are shown in Table 1 below. (Remove IV or remove % DR)

TABLE 1
Polymerization of a 1-decene control sample with
magnetic NPs. Wt. % and % DR were listed.

| | | Drag Reduction |
|---|---|---|
| | Polymerization | (DR) |
| Polymer Suspension | WT % | % DR |
| Polymer only | 95.8 | 48.16 |
| Polymer-co-Magnetic NPs | 94.89 | 48.08 |

### Example 5

Preparation of the drag reducing polymer suspension: Drag reducing polymer containing magnetic nanoparticles from Example 4 was milled at cryogenic temperatures with a partitioning agent. The resulting powder was added to a non-solvent alcohol/glycol suspending fluid. 1 ml of this polymeric suspension was taken and dissolved in 30 ml of diesel to prepare solutions for removal experiments.

### Example 6

Magnetic Capturing: A glass column (length: 3-5 inches) was packed with 1-2 inches of a stainless-steel wool pad. A small (cube 0.5×0.5×0.5 inches, 22 lbs. dragging force) or a medium (rectangle 1×1×0.5 inches, 49.5 lbs. dragging force) magnet was attached on the column exterior adjacent the column section containing the stainless steel wool pad.

The magnetic capturing process was performed using at least one of the three following sample variations: (1) polymer suspensions, (2) polymer co-magnetic nanoparticle suspensions, or (3) polymer co-magnetic nanoparticle suspension with additional magnetic nanoparticle. Each sample was added into the column slowly and the hydrocarbon liquid passing through the column was collected and named as ‘filtered solution.’ After 5 minutes, the external magnet was removed. Pure diesel was used to flush out the retained polymer and/or magnetic NPs from the column, and the collected solution is named as ‘retained solution.’ The concentration of drag reducing polymer in the original solution, filtered solution, and retained solution was measured by GPC. The percentage of drag reducing polymer captured was calculated by the concentration of filtered solution divided by the concentration of original solution as represented by Equation 1.

$$\% DRA polymer = \frac{conc . of polymer in filtered solution ( ppm )}{conc . of polymer in original solution ( ppm )} \qquad ( Equation 1 )$$

The percentage of drag reducing polymer removal was determined by 100% subtracted by the percentage of drag reducing captured in the filtered solution from Equation 1 as represented by Equation 2.

$$\% DRA polymer removal = 100 \% - Equation ( 1 ) \qquad ( Equation 2 )$$

The magnetic nanoparticles with different core sizes (e.g., 8-21 nm, 210 nm, 400 nm) were incorporated in the process of drag reducing polymerization. Various drag reducing dispersion samples were prepared by adding the resulting polymer and magnetic nanoparticle complexes to the diesel fuel. Some dispersion samples include additional amounts of 8-400 nm magnetic nanoparticles to explore magnetic capturing efficiency. Full series of experiments were conducted with the presence of external magnet attraction and the results of these experiments are shown in the Tables below.

Table 2 below shows the removal rate of the drag reducing polymer with different co-magnetic nanoparticles (e.g., 8-21 nm, 210 nm, 400 nm). The external magnet used in Table 2 is a small sized, cubic magnet (0.5×0.5×0.5 inches, neodymium) and a magnetic dragging force of 22.5 lbs. Under the presence of an external magnetic field, the polymer co-magnetic nanoparticles have a better polymer removal rate than the polymer alone. It was observed that inclusion of magnetic NPs ranging from 8 to 400 nm significantly increased the magnetic capturing process's efficiency when responding to the external magnet. The drag reducing polymer with the 21 nm core size resulted in the highest rate of 55% for polymer-NPs complex removal. Ferromagnetic NPs with core sizes ranging from 200 to 400 nm were observed to precipitate due to self-aggregation in the static condition, even though the % polymer removal rates were good.

TABLE 2
The removal rate of drag reducing polymer in dispersion
with magnetic nanoparticles ranging from 8 to 400 nm.

| Drag reducing polymer in suspension | Removal Rate (%) |
|---|---|
| Polymer only | 22 |
| Polymer-co-8 nm Magnetic NPs | 46 |
| Polymer-co-13 nm Magnetic NPs | 53 |
| Polymer-co-21 nm Magnetic NPs | 55 |
| Polymer-co-210 nm Magnetic NPs | 31 |
| Polymer-co-400 nm Magnetic NPs | 40 |

It is possible the magnetic properties of polymer-co-magnetic NPs dispersion are decreased due to the hindering effect of the ultrahigh molecular weight drag reducing polymer network. Experiments were performed by including additional magnetic NPs to the drag reducing polymer in dispersion to boost their magnetic behavior when an external magnet was applied. Based on their superparamagnetic properties and high colloidal stability, the 13 or 21 nm magnetic NPs were selected as the additional magnetic NPs.

In Table 3, the performance of polymer removal percentages was presented for some polymer-co-magnetic NPs suspensions with additional magnetic NPs in the presence of an external magnetic field. Table 3 includes the results using two different magnets: (1) a cubic magnet with a small size (0.5×0.5×0.5 inches, neodymium) and a magnetic dragging force of 22 lbs and (2) a medium-sized neodymium magnet (1×1×0.5 inches) and a magnetic attraction of 55 lbs. It was observed that the additional magnetic NPs enhanced their magnetic behavior, resulting in a higher removal efficiency of polymer from the suspension. The percentage of polymer removal efficiencies using the magnetic capturing process was affected by the magnetic field. A series of polymer-co-magnetic NP suspensions, which were mixed with additional 13 nm magnetic NPs were compared as the magnetic field strength increased. The percentage of polymer removal rates of these polymer suspensions improved, ranging from 36 to 64% as the external magnetic attraction became stronger.

Table 3 below shows the removal rate of drag reducing polymer in dispersion and with additional 13 nm magnetic nanoparticles, with the effects of external magnetic force.

TABLE 3
The removal rate of drag reducing polymer in dispersion
and with additional 13 nm magnetic nanoparticles
with the effects of external magnetic force.

| | | | Removal Rate |
|---|---|---|---|
| | | Removal Rate | (%) |
| | | (%) | 55 lbs external |
| | | 22 lbs external | magnetic force |
| Polymer | | magnetic force | (medium |
| Suspension | Addition | (small magnet) | magnet) |
| Polymer-co-8 nm | 13 nm Magnetic | 40 | 54 |
| Magnetic NPs | NPs | | |
| Polymer-co-13 nm | 13 nm Magnetic | 44 | 58 |
| Magnetic NPs | NPs | | |
| Polymer-co-21 nm | 13 nm Magnetic | 46 | 64 |
| Magnetic NPs | NPs | | |

The viscosity of the polymer typically affects the flow rate, density, and retention efficiency in the column during the magnetic capturing process. The effects of the concentration of DRA polymers were investigated, and the results are presented in Table 4. Prior to the test, the samples were sheared using sonication, and the concentrations of polymer were measured in parts per million (ppm) using by GPC. A series of tests were conducted using a magnetic capturing process with various concentrations of polymer ranging from 10 ppm to 5000 ppm, and the percentage of polymer removal efficiencies was compared. Although the differences in polymer removal were not significant, higher concentration ranges of the sample generally provided higher % removal rates, possibly because high viscosity promotes the high retention/adsorption of the materials in the column.

Table 4 below shows the removal rate of the drag reducing polymer with different co-magnetic nanoparticles and with the external addition of magnetic nanoparticles at various concentrations of polymer ranging from 10 to 5000 ppm.

TABLE 4
The % polymer removal of the Polymer-co-Magnetic NPs suspension
with the optional addition of extra magnetic NPs at various
concentrations of polymer ranging from 10 to 5000 ppm.

| | | | Addition |
|---|---|---|---|
| | | Polymer Suspension | Polymer-co-21 nm |
| | | Polymer-co-21 nm | Magnetic NPs |
| | | Magnetic NPs | suspension + additional 13 |
| | | suspension | nm magnetic NPs |
| Concentration (ppm) | | Removal Rate (%) | Removal Rate (%) |
| 10 | ppm | 22 | 33 |
| 30-150 | ppm | 37 | 43 |
| 500-1000 | ppm | 30 | 40 |
| 2000-5000 | ppm | 35 | 48 |

Embodiments of the present disclosure provide systems and methods of removing at least 30%, at least 35%, or at least 40% of the drag reducing polymers in the dispersion. In some embodiments, the systems and methods can advantageously remove from 25% to 80% or from 30% to 70% of the drag reducing polymers in the dispersion.

In some embodiments, a drag reducing composition includes a drag reducing polymer; a magnetic particle incorporated in the drag reducing polymer; and a suspension fluid medium.

In some embodiments, a method of forming a drag reducing composition includes providing alpha-olefin monomers with a carbon chain length of between two and twenty carbon atoms and providing a polymerization catalyst. A magnetic particle in an amount from 1% to 5% by total volume is added to the drag reducing composition. The method also includes reacting the alpha-olefin monomers in the presence of the polymerization catalyst to produce a drag reducing polymer incorporated with the magnetic particle.

In one or more embodiments described herein, the magnetic particle comprises a magnetic metal, magnetic metal alloy, or magnetic metal oxide.

In one or more embodiments described herein, the magnetic particle includes a magnetic metal selected from the group consisting of Fe, Co, Ni, Nd, Sm, alloys thereof, and combinations thereof.

In one or more embodiments described herein, the magnetic particle further comprises a fatty acid.

In one or more embodiments described herein, the fatty acid is oleic acid, 10-undecenoic acid, lauric acid, myristic acid, stearic acid, linoleic acid, palmitoleic acid, elaidic acid, vaccenic acid, hypogeic acid, oleic acid, gondoic acid, mead acid, erucic acid, decylenic acid, 8-nonenoic acid, 7-octenoic acid or combinations thereof.

In one or more embodiments described herein, the magnetic particle has an average particle size from 5 nm to 500 nm.

In one or more embodiments described herein, the magnetic particle has an average particle size from 8 nm to 50 nm.

In one or more embodiments described herein, the magnetic particle is incorporated into the drag reducing polymer during polymerization of the drag reducing polymer.

In one or more embodiments described herein, the drag reducing polymer comprises alpha-olefin monomers with a carbon chain length of between two and twenty carbon atoms.

In one or more embodiments described herein, the suspension fluid medium comprises an alcohol, glycol, glycol ether, polyunsaturated fatty acid, or water.

In one or more embodiments described herein, the magnetic particle comprises a superparamagnetic metal nanoparticle, superparamagnetic metal oxide nanoparticle, a ferromagnetic metal nanoparticle, or ferromagnetic metal oxide nanonparticle.

In one or more embodiments described herein, the method includes synthesizing the magnetic particle by mixing a magnetic metal oxide with a fatty acid.

In one or more embodiments described herein, the method includes synthesizing the magnetic particle by mixing a fatty acid with a magnetic metal, a magnetic metal alloy, or a magnetic metal oxide.

In another embodiment, a method includes supplying a drag reducing composition into a hydrocarbon stream flowing in a conduit. The drag reducing composition includes a drag reducing polymer and a magnetic nanoparticle. The drag reducing polymer is present in an amount sufficient to reduce a drag of the hydrocarbon stream. The method also includes applying a magnetic force to the hydrocarbon stream and removing at least a portion of the drag reducing polymers using the magnetic force.

In one or more embodiments described herein, the magnetic nanoparticle is incorporated into the drag reducing polymer prior to being supplied into the hydrocarbon stream.

In one or more embodiments described herein, wherein removing the drag reducing polymer comprises attracting the magnetic nanoparticle to the magnetic force.

In one or more embodiments described herein, the magnetic nanoparticle includes a magnetic metal or metal oxide and a fatty acid.

In one or more embodiments described herein, the magnetic nanoparticle includes a fatty acid and one of a magnetic metal, a magnetic metal alloy, or a magnetic metal oxide.

In one or more embodiments described herein, the magnetic metal or metal oxide includes a metal selected from the group consisting of Fe, Co, Ni, Pt, Nd, Sm, alloys thereof, and combinations thereof.

In one or more embodiments described herein, the fatty acid is oleic acid, 10-undecenoic acid, lauric acid, myristic acid, stearic acid, linoleic acid, palmitoleic acid, elaidic acid, vaccenic acid, hypogeic acid, gondoic acid, mead acid, erucic acid, decylenic acid, 8-nonenoic acid, 7-octenoic acid, or combinations thereof.

In one or more embodiments described herein, the drag reducing polymer is formed from alpha-olefin monomers with a carbon chain length of between four and twenty carbon atoms.

In one or more embodiments described herein, the drag reducing composition includes a mixture of a drag reducing polymer and a magnetic nanoparticle.

In one or more embodiments described herein, the magnetic nanoparticle is mixed with the drag reducing polymer, and then added to a hydrocarbon stream.

In one or more embodiments described herein, removing at least a portion of the drag reducing polymers using the magnetic force comprises removing at least 30%, at least 35%, or at least 40% of the drag reducing polymers.

In one or more embodiments described herein, removing at least a portion of the drag reducing polymers using the magnetic force comprises removing from 25% to 80% from 30% to 80%, or from 30% to 70% of the drag reducing polymers.

While the foregoing is directed to implementations of the present disclosure, other and further implementations of the present disclosure may be devised without departing from the basic scope thereof, and the scope thereof is determined by the claims that follow.

1. A drag reducing composition, comprising:
a drag reducing polymer;
a magnetic particle incorporated in the drag reducing polymer; and
a suspension fluid medium.

2. The composition of claim 1, wherein the magnetic particle comprises:
a magnetic metal, a magnetic metal alloy, or a magnetic metal oxide.

3. The composition of claim 1, wherein the magnetic particle includes a magnetic metal selected from the group consisting of Fe, Co, Ni, Nd, Sm, alloys thereof, and combinations thereof.

4. The composition claim 2, wherein the magnetic particle further comprises a fatty acid.

5. The composition of claim 4, wherein the fatty acid is oleic acid, 10-undecenoic acid, lauric acid, myristic acid, stearic acid, linoleic acid, palmitoleic acid, elaidic acid, vaccenic acid, hypogeic acid, oleic acid, gondoic acid, mead acid, erucic acid, decylenic acid, 8-nonenoic acid, 7-octenoic acid or combinations thereof.

6. The composition of claim 1, wherein the magnetic particle has an average particle size from 5 nm to 500 nm.

7. The composition of claim 1, wherein the magnetic particle is incorporated into the drag reducing polymer during polymerization of the drag reducing polymer.

8. The composition of claim 1, wherein the drag reducing polymer comprises alpha-olefin monomers with a carbon chain length of between two and twenty carbon atoms, and
wherein the suspension fluid medium comprises an alcohol, glycol, glycol ether, polyunsaturated fatty acid, or water.

9. The composition of claim 1, wherein the magnetic particle comprises a superparamagnetic metal nanoparticle, superparamagnetic metal oxide nanoparticle, a ferromagnetic metal nanoparticle, or ferromagnetic metal oxide nanonparticle.

10. A method of forming a drag reducing composition, comprising:
providing alpha-olefin monomers with a carbon chain length of between two and twenty carbon atoms;
providing a polymerization catalyst;
providing a magnetic particle in an amount from 1% to 5% by total volume; and
reacting the alpha-olefin monomers in the presence of the polymerization catalyst to produce a drag reducing polymer incorporated with the magnetic particle.

11. The method of claim 10, wherein providing the magnetic particle comprises:
synthesizing the magnetic particle by mixing a magnetic metal core with a fatty acid.

12. The method of claim 11, wherein the magnetic metal core comprises a metal or metal oxide selected from the group consisting of Fe, Co, Ni, Pt, Nd, Sm, alloys thereof, and combinations thereof.

13. The method of claim 11, wherein the fatty acid is oleic acid, 10-undecenoic acid, lauric acid, myristic acid, stearic acid, linoleic acid, palmitoleic acid, elaidic acid, vaccenic acid, hypogeic acid, gondoic acid, mead acid, erucic acid, decylenic acid, 8-nonenoic acid, 7-octenoic acid, or combinations thereof.

14. The method of claim 10, wherein the magnetic particle has an average particle size from 8 nm to 50 nm.

15. A method, comprising:
supplying a drag reducing composition into a hydrocarbon stream flowing in a conduit, the drag reducing composition comprising a drag reducing polymer and a magnetic nanoparticle and present in an amount sufficient to reduce a drag of the hydrocarbon stream;
applying a magnetic force to the hydrocarbon stream; and
removing at least a portion of the drag reducing polymers using the magnetic force.

16. The method of claim 15, wherein the magnetic nanoparticle is incorporated into the drag reducing polymer prior to being supplied into the hydrocarbon stream.

17. The method of claim 16, wherein removing the drag reducing polymer comprises attracting the magnetic nanoparticle to the magnetic force.

18. The method of claim 15, wherein the magnetic nanoparticle comprises:
a magnetic metal or metal oxide; and
a fatty acid.

19. The method of claim 18, wherein the magnetic metal or metal oxide includes a metal selected from the group consisting of Fe, Co, Ni, Pt, Nd, Sm, alloys thereof, and combinations thereof.

20. The method of claim 18, wherein the fatty acid is oleic acid, 10-undecenoic acid, lauric acid, myristic acid, stearic acid, linoleic acid, palmitoleic acid, elaidic acid, vaccenic acid, hypogeic acid, gondoic acid, mead acid, erucic acid, decylenic acid, 8-nonenoic acid, 7-octenoic acid, or combinations thereof.
